(19) United States
(12) Patent Application Publication
(10) Pub. No.: US 2009/0023046 A1
(43) Pub. Date: Jan. 22, 2009

(54) Porous Transport Structures for Direct-Oxidation Fuel Cell System Operating with Concentrated Fuel

(76) Inventors: Chao-Yang WANG, State College, PA (US); Yuusuke SATO, Tokyo (JP); Ryosuke Yagi, Kanagawa-ken (JP)

Correspondence Address: Law Office of John K. Pike, PLLC, 2121 Eisenhower Avenue, Suite 200, Alexandria, VA, 22314, US

(21) Appl. No.: 11/781,175

(22) Filed: Jul. 20, 2007

(51) Int. Cl. H01M 8/02; H01M 4/86

(52) U.S. Cl. 429/35; 429/12; 429/34; 429/40

(57) ABSTRACT

One embodiment provides a direct oxidation fuel cell, comprising, in the following order, a catalyst layer; an optional microporous layer; an optional backing layer; and an electrically conductive porous transport structure, comprising, in the following order, a porous body, and an impermeable layer in contact with the porous body. Another embodiment provides a direct oxidation fuel cell, comprising an electrically conductive porous transport structure, comprising a porous body, and an impermeable layer in contact with the porous body; wherein the direct oxidation fuel cell achieves a net water transport coefficient, α, of less than about 0.6 at an operation temperature ranging from about 60 to about 80° C.

### BACKGROUND

1. Field of the Invention

This invention relates generally to fuel cells for portable power.

2. Discussion of the Background

A direct oxidation fuel cell (“DOFC”) is an electrochemical device that generates electricity from complete electro-oxidation of a liquid fuel. Typical liquid fuels include methanol, ethanol, formic acid, dimethyl ether, aqueous solutions thereof, and combinations thereof. The oxidant may be substantially pure oxygen or a dilute stream such as that in air. Significant advantages of employing a DOFC in portable and mobile applications (e.g. notebook computers, mobile phones, PDAs, etc.) include easy storage/handling and high energy density of the liquid fuel.

One example of a DOFC system is a direct methanol fuel cell (“DMFC”). A DMFC generally employs a membrane-electrode assembly (“MEA”) having an anode, a cathode, and a proton-conducting membrane electrolyte therebetween. A typical example of the membrane electrolyte, sometimes called a polymer electrolyte membrane or PEM is Nafion®, a registered trademark of E.I. Dupont de Nemours and Company. A methanol/water solution is directly supplied to the anode as the fuel, and air is supplied to the cathode as the oxidant. At the anode, methanol reacts with water in the presence of a catalyst, typically a Pt—Ru catalyst, to produce carbon, dioxide, protons and electrons, that is,

CH₃OH+H₂O→CO₂+6H⁺+6e⁻ (1)

The protons migrate to the cathode through the proton conducting membrane electrolyte. The polymer electrolyte membrane is non-conductive to electrons. The electrons travel to the cathode through an external circuit where electric power is delivered. At the cathode, the protons, electrons and oxygen molecules from air are combined in the presence of a catalyst, typically a Pt catalyst, to form water, namely,

3/2O₂+6H⁺+6e⁻→3H₂O (2)

The two electrochemical reactions (1) and (2) form an overall cell reaction as:

CH₃OH+3/2O₂→CO₂+2H₂O (3)

In general, in a DMFC the methanol partly permeates the membrane electrolyte from the anode to the cathode. This methanol is called “crossover methanol”. Crossover methanol reacts with oxygen at the cathode, which reduces the fuel cell's fuel utilization efficiency and cathode potential, with the result that less power is generated by the fuel cell. In addition to methanol, water also crosses over through the membrane. This “crossover water” is driven at least in part by electroosmotic drag and diffusion, with the result that significant amounts of water are lost from the anode.

In order to limit methanol crossover and its detrimental consequences, and to supply sufficient water to sustain excessive water crossover to the cathode through the membrane, conventional DMFC systems use dilute (3-6% by vol.) methanol solutions at the anode. The problem with such systems is that the significant amounts of water required create a burden on a portable system, and they sacrifice the energy density of the system.

The ability to use high concentration fuel is highly desirable for portable power sources, as DMFC technology competes with lithium-ion and other advanced batteries. It has been shown (U.S. Published Appl. Nos. 2006/0134487 and 2007/0087234, both incorporated herein by reference in their entireties) that achieving low or negative water crossover from the anode through the membrane to the cathode is one key to operating fuel cells with high concentration methanol fuel.

One measure of water crossover through a membrane is the net water transport coefficient, or α. The net water transport coefficient is defined as the number of water molecules per proton which penetrate the electrolyte membrane. The net water transport coefficient, α, is a known term and is described, for example in U.S. Published Appl. No. 2007/0087234, already incorporated by reference. Theoretical α-values for a DMFC to operate directly using methanol are 0.52, 0.05 and −0.167 for methanol fuel concentrations of 10M, 17M and 24M (neat methanol), respectively.

Heretofore, low-α membrane-electrode assemblies (MEAs) have been made by two principal methods. One is to utilize liquid water backflow through a thin Nafion membrane as described in U.S. Published Application No. 2006/0134487. In this approach, α=0.4 has been demonstrated at 60° C. by using a highly hydrophobic microporous layer in an air-circulating cathode and a thin membrane (e.g. Nafion 112). The other approach is to use hydrocarbon membranes. For example, α=1.3 was demonstrated for sulfonated poly(arylene ether benzonitrile) membranes (Y. S. Kim, M. J. Sumner, W. L. Harrison, J. S. Riffle, J. E. McGrath, and B. S. Pivovar, Direct Methanol Fuel Cell Performance of Disulfonated Poly(arylene ether benzonitrile) Copolymers, J. Electrochem. Soc., Vol. 151, pp. A2157-A2172, December 2004, the entire contents of which being hereby incorporated by reference).

U.S. Pat. No. 5,599,638 discloses an aqueous liquid feed organic fuel cell using solid polymer electrolyte membranes.

### BRIEF DESCRIPTION OF THE DRAWINGS

FIG. 1 shows a schematic illustration of one embodiment of the present invention.

FIG. 2 shows a schematic illustration of another embodiment of the present invention.

FIG. 3 shows a schematic illustration of another embodiment of the present invention.

FIG. 4 shows a schematic illustration of another embodiment of the present invention.

FIG. 5 shows a schematic illustration of another embodiment of the present invention.

FIG. 6 shows a schematic illustration of another embodiment of the present invention.

FIG. 7 shows a schematic illustration of another embodiment of the present invention.

FIGS. 8a and 8b show two views of another embodiment of the invention, wherein FIG. 8b is a section view along line A-A′ in FIG. 8a.

FIG. 9 shows a graph of the measured net water transport coefficients, α, versus cathode air stoichiometry or flow rate for the exemplified embodiment of the present invention and for the comparative example.

FIG. 10 shows a graph of the voltage curves for the exemplified embodiment of the present invention discharged at 150 mA/cm² and 60° C. The “α=0.09, 0.085, and 0.056” data in the legend correspond to the top, middle, and bottom curves in the graph, respectively.

### DESCRIPTION OF THE SEVERAL EMBODIMENTS

One embodiment of the present invention provides a porous transport structure that results in an ultralow or negative water crossover from the anode to cathode.

One embodiment of the present invention provides a direct oxidation fuel cell capable of operating directly on high concentration fuel from a cartridge or other source (including neat methanol) without recovery of water from the cathode exhaust. The direct oxidation fuel cell exhibits high performance using high concentration fuels and elevated cell temperature.

In one embodiment, a porous transport structure is provided on the cathode side of a polymer electrolyte membrane, which results in ultralow or negative water crossover from the anode to cathode.

One embodiment provides a fuel cell for portable power. Another embodiment provides a direct methanol fuel cell that operates with a direct feed of high concentration fuel at the anode.

One embodiment provides a direct oxidation fuel cell, comprising, in the following order:
catalyst layer;
an optional microporous layer;
an optional backing layer; and
an electrically conductive porous transport structure, comprising, in the following order:
   a porous body, and
   an impermeable layer in contact with the porous body.

One embodiment provides a direct oxidation fuel cell, comprising:
an electrically conductive porous transport structure, comprising:
   a porous body, and
   an impermeable layer in contact with the porous body;
wherein the direct oxidation fuel cell achieves a net water transport coefficient, α, of less than about 0.6 at an operation temperature ranging from about 60 to about 80° C.

In one embodiment, the direct oxidation fuel cell achieves a net water transport coefficient, α, of less than about 0.6. This includes all values and subranges therebetween, including 0.6, 0.55, 0.5. 0.52, 0.5, 0.45, 0.4, 0.35, 0.33, 0.3, 0.25, 0.2, 0.15, 0.14, 0.1, 0.05, 0.01, 0.00 and −0.167.

In one embodiment, the present invention provides a fuel cell that achieves α-values between 0.1 and −0.167 in an active air-flowing system under temperatures of 60 to about 80° C., thus permitting direct feed of 15-24M methanol at the anode.

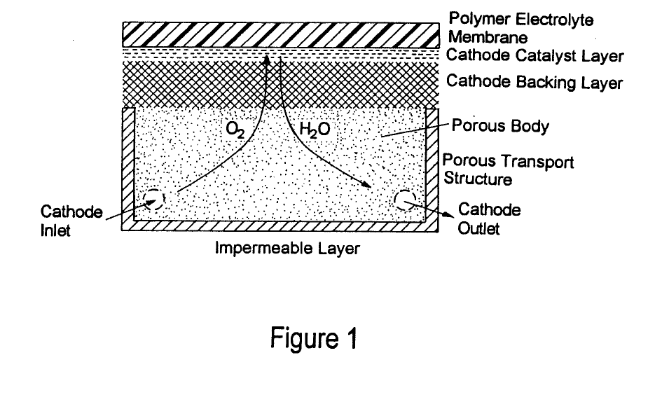

In conventional direct oxidation fuel cells, the cathode side typically includes a cathode catalyst layer bonded to the polymeric electrolyte membrane, a backing layer with or without a microporous layer, and a flow field with parallel or serpentine channels machined on the surface of a bipolar plate made of either graphite or a metal. In one embodiment of the present invention, the cathode side includes a cathode catalyst layer and a porous transport structure either with or without a backing layer and/or microporous layer sandwiched therebetween. In one embodiment, the porous transport structure includes a porous body with one open side facing the catalyst layer and an opposing side that is sealed by an impermeable layer. FIG. 1 schematically illustrates one embodiment of such a porous transport structure.

As shown in FIG. 1, the porous transport structure includes a porous body and an impermeable layer. The porous transport structure must be electrically conductive. In one embodiment, the porous body and the impermeable layer are not electrically conductive. In this embodiment, the electrical contact is taken up by one or more electrically conductive materials through or around or a combination of through and around the porous body and impermeable layer. In another embodiment, the porous body is electrically conductive, and the impermeable layer is not electrically conductive. In another embodiment, the porous body is not electrically conductive and the impermeable layer is electrically conductive. In another embodiment, both the porous body and the impermeable layer are electrically conductive. As used herein, the terms, “porous” and “impermeable” are with respect to fluids, such as liquids and gases.

In one embodiment, the porous transport structure includes one or more electrically conductive materials in contact with the porous body. The electrically conductive materials are not particularly limited, and may include one or more of electrically conductive pins, vias, mesh, coating, and combinations thereof.

As illustrated in FIG. 1, when dry air is fed into the cathode inlet, for example, at the left corner of the porous transport structure, the air flows and/or diffuses through the porous body of the porous transport structure, permeates through the backing and catalyst layers, and eventually reacts in the cathode catalyst layer to produce water. Subsequently, the product water migrates through the catalyst and backing layers into the porous body of the porous transport structure. The exhaust is removed from the cathode outlet. One function of the porous transport structure is to retain water inside the cathode and promote internal humidification, thereby achieving ultralow or negative water flow from the anode to cathode. This is accomplished, at least in part, by the tortuous paths within the porous transport structure. The porous transport structure also functions to deliver reactants and remove products from the catalyst layers. The porous transport structure may be utilized on either or both of the anode side or cathode side.

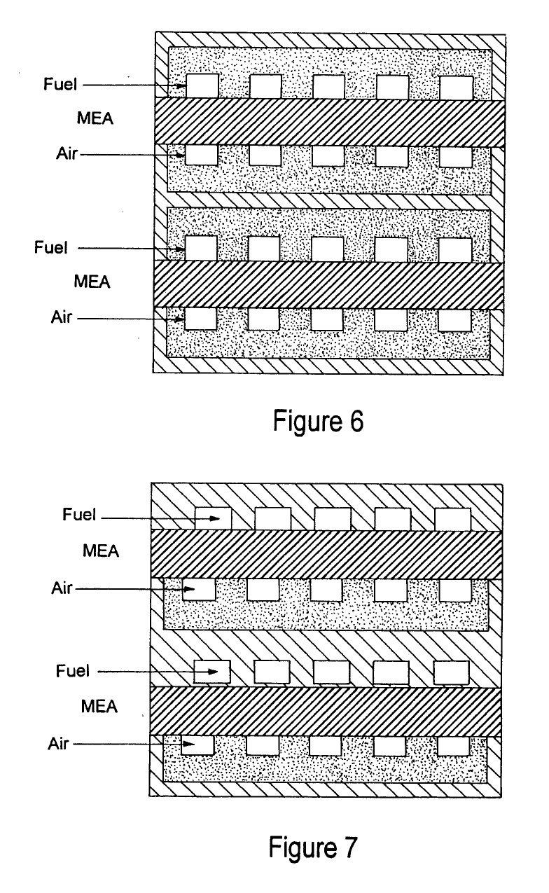

The impermeable layer in the porous transport structure prevents or substantially prevents reactants and product water from leaking out of the cell, thus keeping moisture inside the cathode and hence reducing the water transport coefficient α through the membrane. Experimental measurements of α in a cell composed of a porous transport structure with an impermeable layer opposing the cathode catalyst layer, as shown in FIG. 6, confirm five- to ten-fold reduction in α as compared to that without the impermeable surface.

The porous body may have a thickness between about 100 μm and about 2 mm. This includes all values and subranges therebetween, including about 100, 200, 300, 400, 500, 600, 700, 800, 900 μm, and about 1 and 2 mm. The lower limit of 100 micrometers is preferable in view of maintaining the air pressure drop through the cell within a reasonable range for portable devices. The upper limit of 2 millimeters is desirable to keep the volume of a single cell small and hence the resulting fuel cell stack compact.

In one embodiment, the porous body includes pores having pore sizes of about 5 μm or more. This includes all values and subranges therebetween, including about 5, 6, 7, 8, 9, 10, 15, 20, 25, 30, 35, 40, 45, 50, 55, 60, 65, 70, 75, 80, 85, 90, 95 and 100 μm.

In one embodiment, the porous body has a porosity of greater than 50%. This includes all values and subranges therebetween, including 50, 55, 60, 65, 70, 75, 80, 85, 90, and 95% porous.

The porous body may be suitably made from any corrosion-resistant porous material. The porous body may be made of electrically conductive material non-electrically conductive material, or a combination of electrically conductive and non-electrically conductive material. Some non-limiting examples of porous body materials include carbon paper, carbon cloth, porous carbon, metal foam, material or any composite, or a combination thereof. The porous body may be fully or partially treated, if desired, with one or more hydrophilic or hydrophobic agents. Such hydrophilic and hydrophobic agents are known, and any surface active agent or surface treating agent may be suitably selected depending on the properties desired. The porous body may have an electrically conductive coating, for example, an electrically conductive metal or carbon coating or even a conductive polymer coating. Combinations of coatings are possible.

The impermeable layer may be suitably made from any impermeable material. In one embodiment, the impermeable layer is made from corrosion-resistant impermeable material. The impermeable layer may be made from any electrically conductive material, non-electrically conductive material, or a combination of electrically conductive and non-electrically conductive material. In one embodiment, the impermeable layer is made of graphite, metal, or a combination thereof.

The thickness of the impermeable layer is not particularly limited, so long as the layer is impermeable or substantially impermeable to fluids such as liquids and gases. The impermeable layer may have a thickness ranging from about 30 μm to less than about 1 mm. This range includes all values and subranges therebetween, including about 30, 35, 40, 45, 50, 55, 60, 65, 70, 75, 80, 85, 90, 95, 100, 200, 300, 400, 500, 600, 700, 800, 900 μm, and less than about 1 mm.

In one embodiment, the porous body further includes one or more sides, which may be sealed by one or more side impermeable walls to prevent fluids from leaking out of the cell. The side impermeable walls may or may not be electrically conductive. In one embodiment, the side impermeable walls are the same material as the impermeable layer. In one embodiment, the side impermeable walls are made of a different material as the impermeable layer.

The porous transport structure may include one or more channels therein. The channels may form parallel, serpentine or interdigitated flow fields. The channels may have any cross section. For example, they may be rectangular, circular, square, oval, or any other cross section. The channels may be machined on the surface or embedded inside the interior of the porous transport structure.

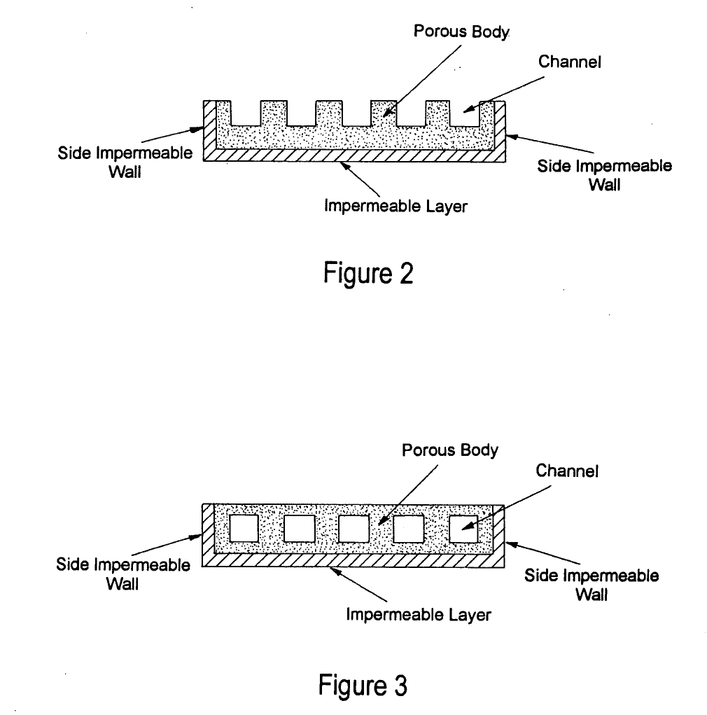

One embodiment is illustrated in FIG. 2, which shows a porous transport structure with open-faced channels machined on the surface facing the cathode catalyst layer.

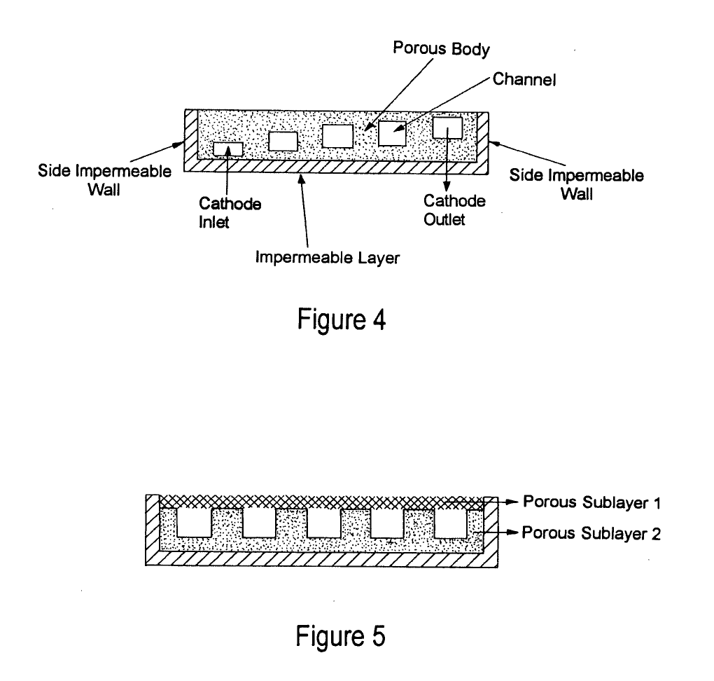

In one embodiment, rectangular or circular channels are embedded inside the porous body, such as shown in FIG. 3. In another embodiment, such as shown in FIG. 4, the embedded channels have non-uniform distances to the open surface of the porous transport structure. In one embodiment, the distance between the channel center and the surface facing the cathode catalyst layer decreases from the cathode inlet region to the outlet region. This is to protect membrane dryout from incoming dry air (in part by providing a longer diffusion length in the inlet region) and to improve oxygen transport in the outlet region (in part by providing a shorter diffusion length where the air in the flow channel has a low oxygen content). The channels may be centered with different distances away from the catalyst layer, and the channel-to-catalyst layer distance may be tailored to simultaneously prevent membrane dryout at the inlet region and oxygen depletion at the outlet region. The porous transport structure with embedded channels shown in FIG. 4 has another added benefit in that the contact resistance in the cell is substantially reduced as the contact area at the interface between the catalyst/backing layer and the porous transport structure is much larger than that between the backing layer and bipolar plate with surface channels in conventional cells.

In one embodiment, the channels have a dimension ranging from about 0.3 to 2 mm wide, and from about 200 μm to about 1 mm deep. These ranges include all values and subranges therebetween, including about 0.3, 0.4, 0.5, 0.75, 1, 1.25, 1.5, 1.75 and 2 mm wide; and about 200, 300, 400, 500, 600, 700, 800, 900 μm and 1 mm deep. The channels within any one porous transport structure or among several porous transport structures may have the same or different dimension.

In one embodiment, the porous transport structure may be a composite of two or more sublayers made of different porous materials, as shown in FIG. 5. Each sublayer may have different microstructure, pore size, porosity, wetting treatment (i.e. hydrophilic or hydrophobic), and layer thickness. These may be suitably selected given the teachings herein combined with one of ordinary skill in this art.

Porous transport structures with three-dimensional channel architectures may be fabricated by machining, injection molding, extrusion, selective sintering front powders, lamination, etc.

FIGS. 6 and 7 illustrate two stack configurations composed of cells using the porous transport structure. One stack displayed in FIG. 6 uses the porous transport structure for both anode and cathode plates with one impermeable wall to separate the anode side from the cathode. On the other hand, in FIG. 7 the stack includes conventional solid plates for the anode but includes porous transport structures for the cathode. Other combinations are also contemplated.

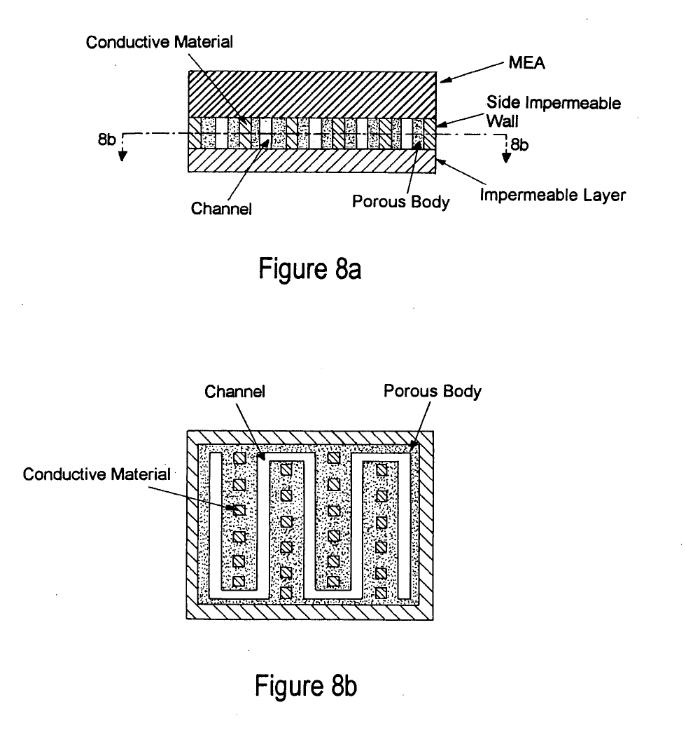

FIGS. 8a and 8b illustrate two views of one embodiment, wherein the porous transport structure includes an electrically conductive material and also channels through the porous body part. FIG. 8b is a section view along line A-A′ in FIG. 8a. In this embodiment, the porous body is not electrically conductive and the impermeable layer is electrically conductive. The electrical contact is made with the electrically conductive material shown in the Figure. The side impermeable walls may or may not be electrically conductive.

The polymer electrolyte membrane is not particularly limited, and, given the teachings herein combined with the knowledge of one of ordinary skill in this art, may be suitably selected from known membranes. Some examples of the polymer electrolyte membrane include fluorinated or hydrocarbon membranes.

The cathode side can be either air circulating or air breathing. No water recovery from the cathode side is necessary.

The microporous layer, if present, is not particularly limited. One function of the microporous layer is to provide a smooth contact between the catalyst layer and the gas diffusion layer. The microporous layer is much thinner than the porous transport structure, and it contains much smaller pores. Unlike the porous transport structure, the microporous layer does not function as a wick. In one embodiment, the microporous layer has a thickness ranging from about 10-60 μm. This range includes all values and subranges therebetween, including about 10, 15, 20, 25, 30, 35, 40, 45, 50, 55 and 60 μm. In one embodiment, the pore sizes in the microporous layer range from about 50 to 100 nm. This range includes all values and subranges therebetween, including about 50, 60, 70, 80, 90 and 100 nm.

The microporous layer may be suitably made from carbon powders and PTFE.

The backing layer, if present, is not particularly limited. One function of the backing layer is to allow for reactant distribution into the electrode. Another function is to conduct electrons laterally to the current collecting lands in the cell. The backing layer also helps to remove product water from the cathode and product carbon dioxide from the anode. In one embodiment, the backing layer has a thickness ranging from about 50 to 400 μm. This range includes all values and subranges therebetween, including about 50, 100, 150, 175, 200, 225, 250, 300, 350 and 400 μm. In one embodiment, the backing layer has pore sizes ranging from about 10-30 μm. The backing layer may be suitably be made from carbon paper, carbon cloth, or a combination thereof.

In one embodiment, the fuel cell includes, in order, a catalyst electrode layer, a microporous layer, a backing layer, a porous transport structure, which includes, in order, a porous body and an impermeable layer in contact with the porous body. The catalyst electrode layer may be a cathode or an anode catalyst layer.

In one embodiment, the fuel cell includes, in order, a catalyst electrode layer, a backing layer, a porous transport structure, which includes, in order, a porous body and an impermeable layer in contact with the porous body. The catalyst electrode layer may be a cathode or an anode catalyst layer.

In one embodiment, the fuel cell includes, in order, a catalyst electrode layer, a microporous layer, a porous transport structure, which includes, in order, a porous body and an impermeable layer in contact with the porous body. The catalyst electrode layer may be a cathode or an anode catalyst layer.

The catalyst layers for the anode and cathode are not particularly limited, and may be suitably selected by one of ordinary skill without undue experimentation given the teachings herein. In one embodiment, a Pt—Ru catalyst is used for the anode, and a Pt catalyst is used for the cathode.

The polymer electrolyte membrane is not particularly limited, and may be suitably selected by one of ordinary skill without undue experimentations given the teachings herein. In one embodiment, the polymer electrolyte membrane is a Nafion® membrane.

The fuel cell may operate on any fuel suitable for use in direct oxidation fuel cells. Examples of such fuels include methanol, ethanol, other alcohols, formic acid, dimethyl ether, aqueous solutions thereof, and combinations thereof. In one embodiment, either an aqueous solution of methanol or neat methanol is used as a fuel. The fuel cell may suitably use methanol fuel at a concentration ranging from 1 to 24 M methanol in water, or any concentration therebetween. For example, 1, 2, 3, 4, 5, 6, 7, 8, 9, 10, 11, 12, 13, 14, 15, 16, 17, 18, 19, 20, 21, 22, 23 and 24 M methanol may be used. In one embodiment, the methanol concentration ranges from 10-24 M. In another embodiment, methanol concentrations ranging from 15-24 M may be used. In one embodiment, the fuel is 30% by weight of methanol in an aqueous methanol solution. In another embodiment, the fuel is pure or substantially pure methanol.

In one embodiment, the fuel cell provides from 100 mW to 100 W of power, which range includes 100, 200, 300, 400, 500, 600, 700, 800, or 900 mW, 1, 2, 3, 4, 5, 6, 7, 8, 9, 10, 15, 20, 25, 30, 35, 40, 45, 50, 60, 70, 80, 90, or 100 W, or any value, including any non-integer value therebetween or any combination thereof.

One embodiment provides a membrane electrode assembly, which includes an anode, a cathode, a proton-conducting membrane electrolyte therebetween, and one or more porous transport structures on the cathode side, the anode side, or both.

One embodiment provides a direct methanol fuel cell, which includes the porous transport structure.

The fuel cell, which may include a plurality of stacks, may be assembled according to known methods.

The fuel cell is suitable as a power source for any electronic or other device, for example, as a battery replacement, supplement, or back up. Some non-limiting examples of electronic devices include computers, personal digital assistants, cell phones, cameras, portable music devices, handheld game devices, or combinations thereof. Other devices in which the fuel cell is applicable include generators, automobiles, motorcycles, scooters, household appliances, or combinations thereof. In one embodiment, the fuel cell is electrically connected to the device such that it functions as a source of electrical power.

In one embodiment, the device or fuel cell may suitably include one or more means to store fuel and/or deliver fuel to the fuel cell, for example, a fuel cartridge, fuel tank, or fuel line, or a combination thereof. For example, the fuel cell may incorporate a dual pump anode system such as disclosed in U.S. Published Application No. 2007/0087234, already incorporated herein by reference.

The fuel cell may also incorporate the upwind water barrier such as disclosed in U.S. Published Application No. 2006/0134487, already incorporated herein by reference.

### EXAMPLES

The following example is provided for illustration purposes only and is not intended to be limiting unless otherwise specified.

A fuel cell in accordance with one embodiment of the invention having a 12 cm² active area was prepared. The cathode backing layer was a carbon cloth gas diffusion layer (“GDL”) of 300 μm in thickness with a 30 μm thick microporous layer (MPL). The cathode porous transport structure was a porous carbon block with open square channels machined on the surface as shown in FIG. 2. The anode backing layer was a Toray carbon paper TGPH 090 having a thickness of 260 μm. The anode bipolar plate was a conventional two-pass serpentine flowfield. The membrane electrode assembly (MEA) was made by hot-pressing the anode backing layer and cathode backing layer onto a catalyst coated Nafions® 112 membrane. The loadings of Pt—Ru black on the anode and Pt black on the cathode (Alfa Aesar, a Johnson Matthey Company) were 5.8 mg/cm² and 4.9 mg/cm², respectively. The cell was operated at 60° C., and under 2 M methanol on the anode and dry air on the cathode, respectively.

A comparative cell was prepared, which was identical to the exemplified cell, but which used a conventional solid bipolar plate with grooves in place of the cathode porous transport structure.

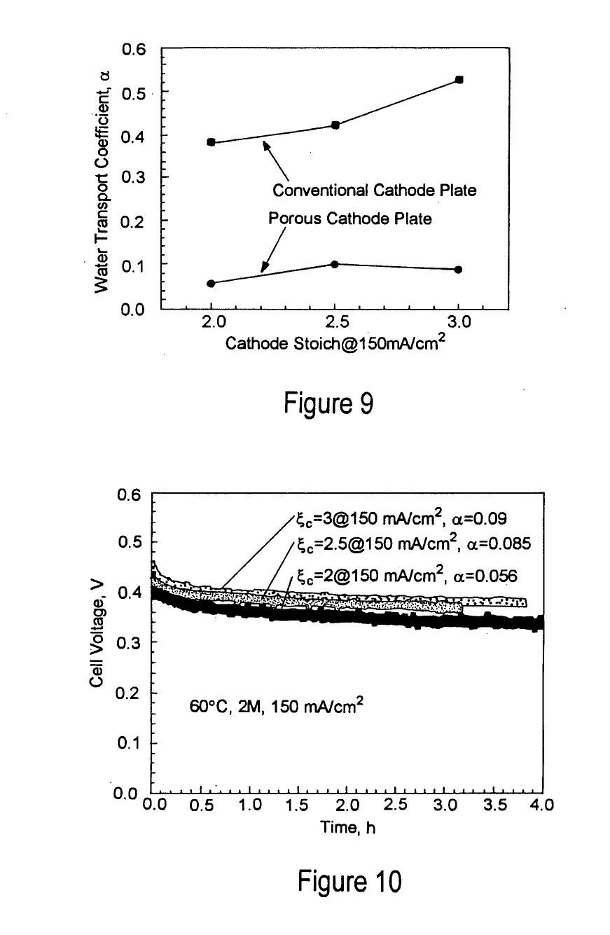

FIG. 9 shows the measured water transport coefficient, α, through the membranes in the respective exemplary and comparative cells. The water transport coefficient for the exemplary cell is lower than 0.1 and insensitive to the air flowrate. The α-values observed for the exemplified embodiment are about five- to ten-fold less than those observed for the comparative example, which lacks the porous transport structure.

FIG. 10 shows the voltage curve of the 12 cm² cell discharged at 150 mA/cm² while feeding with 2M methanol fuel and operating at 60° C. The cell voltage measured varies from 0.36 to 0.41V and the power density varies from 54 to 61.5 mW/cm² for the cathode air stoichiometry between 2 and 3. The water crossover coefficient for the exemplified embodiment was measured to be 0.056-0.09, as compared to 0.6 in a conventional DMFC without porous transport structure for the cathode side under otherwise all the same conditions and cell structure.

This example thus demonstrates the effectiveness of the present invention in achieving low or negative water flow from the anode to cathode and hence in permitting the use of concentrated fuel, with no recovery of water from the cathode exhaust.

Having fully described the invention, it should be apparent that it can be practiced without resorting to the details so specifically set forth herein.

What is claimed is:

1. A direct oxidation fuel cell, comprising, in the following order:
a catalyst layer;
an optional microporous layer;
an optional backing layer; and
an electrically conductive porous transport structure, comprising, in the following order:
a porous body, and
an impermeable layer in contact with the porous body.

2. The direct oxidation fuel cell of claim 1, wherein the porous body is electrically conductive.

3. The direct oxidation fuel cell of claim 1, wherein the porous transport structure further comprises one or more electrically conductive materials in contact with the porous body.

4. The direct oxidation fuel cell of claim 3, wherein the electrically conductive materials are selected from the group consisting of electrically conductive pins, vias, mesh, coating, and a combination thereof.

5. The direct oxidation fuel cell of claim 1, wherein the impermeable layer is electrically conductive.

6. The direct oxidation fuel cell of claim 1, wherein the porous body has a thickness between about 100 μm and about 2 mm.

7. The direct oxidation fuel cell of claim 1, wherein the porous body comprises pores having pore sizes of about 5 μm or more.

8. The direct oxidation fuel cell of claim 1, wherein the porous body comprises carbon paper, carbon cloth, porous carbon, metal foam, or a combination thereof.

9. The direct oxidation fuel cell of claim 1, wherein the porous body further comprises one or more porous body sublayers.

10. The direct oxidation fuel cell of claim 1, wherein the porous body further comprises one or more sides, which are sealed by one or more side impermeable walls.

11. The direct oxidation fuel cell of claim 10, wherein the side impermeable walls are not electrically conductive.

12. The direct oxidation fuel cell of claim 10, wherein the side impermeable walls are comprised of the same material as the electrically conductive impermeable layer.

13. The direct oxidation fuel cell of claim 1, wherein the porous transport structure further comprises one or more channels therein.

14. The direct oxidation fuel cell of claim 1, wherein the porous transport structure further comprises a plurality of channels therein, said channels connecting an inlet region to an outlet region, and wherein a distance between a channel and the catalyst layer decreases from the inlet region to the outlet region.

15. The direct oxidation fuel cell of claim 1, wherein the porous transport structure further comprises a plurality of channels therein, said channels having a non-uniform distance to the catalyst layer.

16. The direct oxidation fuel cell of claim 1, wherein the impermeable layer comprises graphite, metal, or a combination thereof.

17. The direct oxidation fuel cell of claim 1, which further comprises a cathode exhaust, and which is configured to operate without recovering water from the cathode exhaust.

18. The direct oxidation fuel cell of claim 1, wherein the direct oxidation fuel cell achieves a net water transport coefficient, α, of less than about 0.6.

19. The direct oxidation fuel cell of claim 1, wherein the catalyst layer is a cathode catalyst layer.

20. The direct oxidation fuel cell of claim 1, further comprising the microporous layer, the backing layer, or both.

21. The direct oxidation fuel cell of claim 1, which is a direct methanol fuel cell.

22. A device, comprising, as a power source, the direct oxidation fuel cell of claim 1.

23. The device of claim 22, which is selected from the group consisting of computer, personal digital assistant, cell phone, camera, portable music device, handheld game device, generator, automobile, motorcycle, scooter, household appliance, and a combination thereof.

24. A direct oxidation fuel cell, comprising:
an electrically conductive porous transport structure, comprising:
a porous body, and
an impermeable layer in contact with the porous body;
wherein the direct oxidation fuel cell achieves a net water transport coefficient, α, of less than about 0.6 at an operation temperature ranging from about 60 to about 80° C.
